(19) United States
(12) Patent Application Publication
(10) Pub. No.: US 2018/0086868 A1
(43) Pub. Date: Mar. 29, 2018

(54) METHODS OF MAKING PRESSURE SENSITIVE ADHESIVE COMPOSITIONS

(71) Applicant: Rohm and Haas Company, Collegeville, PA (US)

(72) Inventor: Katherine Sue Rice, Glenside, PA (US)

(21) Appl. No.: 15/563,401

(22) PCT Filed: Mar. 2, 2016
(86) PCT No.: PCT/US2016/020426

§ 371 Date: Sep. 29, 2017

Related U.S. Application Data
(60) Provisional application No. 62/141,091, filed on Mar. 31, 2015.

(51) Int. Cl. C08F 220/18; C09J 7/02; C09J 133/08

(52) U.S. Cl. CPC C08F 220/18; C09J 7/0217; C09J 133/08; C09J 2433/00; C08F 2800/20; C09J 2205/114; C08F 2220/1825

(57) ABSTRACT

Disclosed is a method comprising: a) dispersing a first monomer mixture comprising least one least monomer, the first monomer mixture having a total glass transition temperature (Tg) in the range of from −10° C. to −50° C. with a surfactant and an initiator in an aqueous medium; b) when the first monomer mixture is at least 85% dispersed, adding a second monomer mixture comprising at least one monomer, the second monomer mixture having a Tg at least 20° C. greater than the Tg of the first monomer mixture, to the aqueous medium; and c) forming a polymer with the first and second monomer mixtures. Also disclosed is a pressure sensitive adhesive comprising the polymer formed by this method.

### REFERENCE TO RELATED APPLICATIONS

The present application claims the benefit of U.S. Provisional Application No. 62/141,091, filed on Mar. 31, 2015.

### FIELD OF INVENTION

The instant disclosure relates to pressure sensitive adhesive compositions, and methods of making the same.

### BACKGROUND OF THE INVENTION

The use of pressure sensitive adhesives in different end-use applications is generally known. A pressure sensitive adhesive must have sufficient adhesion and cohesion to a substrate. The adhesive must adhere instantaneously to the substrate upon the application of pressure. Cohesion comes into play during such steps as converting where low cohesion can be an indication of too much ooze.

Pressure sensitive adhesives are prepared by mixing polymers with additives such as tackifiers and fillers. Typically, adhesive and cohesive strength are at odds with each other. Improving both properties simultaneously is difficult.

Therefore, a preparation process resulting in pressure sensitive adhesives with increased cohesive strength and adhesion would be desirable.

### SUMMARY OF THE INVENTION

A method is disclosed comprising: a) dispersing a first monomer mixture comprising at least one monomer, the first monomer mixture having a total glass transition temperature (Tg) in the range of from −10° C. to −50° C., together with a surfactant and an initiator in an aqueous medium; b) when the first monomer mixture is at least 85% dispersed in the aqueous medium, adding a second monomer mixture to the aqueous medium comprising at least one monomer, the second monomer mixture having a Tg at least 20° C. greater than the Tg of the first monomer mixture; and c) forming a polymer with the first and second monomer mixtures.

A pressure sensitive adhesive comprising the polymer formed according to the method is also disclosed.

The pressure sensitive adhesive composition may further include optionally one or more surfactants, one or more dispersants, one or more thickeners, one or more pigments, one or more fillers, one or more freeze-thaw agent, one or more neutralizing agents, one or more plasticizers, one or more tackifiers, one or more adhesion promoters, one or more crosslinkers, one or more defoamers, and combinations thereof.

### DETAILED DESCRIPTION OF THE INVENTION

Emulsion polymerization is a well-known process, such as, for example as disclosed in U.S. Pat. Nos. 4,325,856, 4,654,397, and 4,814,373.

The first monomer mixture comprises at least one monomer. In some embodiments, the first monomer mixture comprises a mixture of more than one monomer. The resulting first monomer mixture will have a total glass transition temperature (Tg) in the range of from −10° C. to −50° C. Any and all temperatures between −10 and −50° C. are included herein and disclosed herein, for example, the first monomer mixture can have a total Tg in the range of from −15° C. to −45° C., −20° C. to −40° C., or −25° C. to −30° C.

As used herein, the term “glass transition temperature” or “Tg” refers to the glass transition temperature of a material as determined by Differential Scanning calorimetry (DSC) scanning from −90° C. to 150° C. at a rate of 20° C./min on a DSCQ2000 manufactured by TA Instrument, New Castle, Del. The Tg is the inflection point of the curve of heat flow vs. temperature or the maximum value on the plot of its derivative.

Examples of monomers that can be used in the first monomer mixture include, but are not limited to, butyl acrylate, ethylhexyl acrylate, ethyl acrylate, methyl acrylate, octyl methacrylate, isooctyl methacrylate, decyl methacrylate, isodecyl methacrylate, lauryl methacrylate, pentadecyl methacrylate, stearyl methacrylate, octyl acrylate, isooctyl acrylate, decyl acrylate, isodecyl acrylate, lauryl acrylate, C₁₂ to C₁₈ alkyl methacrylates, cyclohexyl acrylate, cyclohexyl methacrylate and combinations thereof.

The second monomer mixture is added to the dispersion after 85% of the first monomer mixture is dispersed. In some embodiments, the second monomer mixture is added after 90% of the first monomer mixture is dispersed and, in some other embodiments, the second monomer mixture is added after 95% of the first monomer mixture is dispersed.

The second monomer mixture also comprises at least one monomer. In some embodiments, the second monomer mixture comprises a mixture of more than one monomer. The resulting second monomer mixture will have a total Tg at least 20° C. greater than the total Tg of the first monomer mixture.

Examples of monomers that can be used in the second monomer mixture include, but are not limited, to methyl methacrylate, isobutyl methacrylate, ethyl acrylate, and combinations thereof.

The initiator for use in the process for the production of the polymer can be either a thermal initiator or a redox system. Thermal initiators include, but are not limited to ammonium persulfate. If the initiator is a redox system, the reducing agent can be an ascorbic acid, a sulfoxylate or an erythorbic acid, while the oxidating agent can be a peroxide or a persulfate.

A surfactant is a compound that reduces surface tension when dissolved in water or water solutions, or that reduces interfacial tension between two liquids, or between a liquid and a solid. Surfactants useful for preparing a stable dispersion in the practice of the present invention may be cationic surfactants, anionic surfactants, zwitterionic, or a non-ionic surfactants. Examples of anionic surfactants include, but are not limited to, sulfonates, carboxylates, and phosphates. Examples of cationic surfactants include, but are not limited to, quaternary amines Examples of non-ionic surfactants include, but are not limited to, block copolymers containing ethylene oxide and silicone surfactants, such as ethoxylated alcohol, ethoxylated fatty acid, sorbitan derivative, lanolin derivative, ethoxylated nonyl phenol or alkoxylated polysiloxane.

Together, the first and second monomer mixtures form a polymer. The polymer can have composite particles of either the same or different sizes.

In some embodiments of the disclosure, there is provided a pressure sensitive adhesive comprising the polymer formed by the above method. The pressure sensitive adhesive composition may further include, optionally, one or more thickeners, one or more pigments, one or more fillers, one or more freeze-thaw agents, one or more neutralizing agents, one or more plasticizers, one or more tackifiers, one or more adhesion promoters, and combinations thereof.

The pressure sensitive adhesive composition may further include, optionally, one or more thickeners. The pressure sensitive adhesive composition may comprise 0.1 to 5 percent by weight of one or more thickeners. All individual values and subranges from 0.1 to 5 weight percent are included herein and disclosed herein. For example, the weight percent of thickeners can be from a lower limit of 0.1, 0.2, 0.3, or 0.5 weight percent to an upper limit of 1, 2, 3, 4, or 5 weight percent. Such thickeners are commercially available under the tradename UCAR™ or Celosize™ from the Dow Chemical Company, Midland, Mich.

The pressure sensitive adhesive composition may further include, optionally, one or more pigments. The pressure sensitive adhesive composition may comprise 0 to 10 percent by weight of one or more pigments. All individual values and subranges from 0 to 10 weight percent are included herein and disclosed herein. For example, the weight percent of pigments can be from a lower limit of 0.1, 0.2, 0.3, 0.5, 1, 2, 3, 4, or 5 weight percent to an upper limit of 1, 2, 3, 4, 5, 6, 7, 8, 9, or 10 weight percent. Such pigments include, but are not limited to, titanium dioxide, which are commercially available under the tradename Ti-Pure™ from the DuPont, Wilmington, Del., USA.

The pressure sensitive adhesive composition may further include, optionally, one or more fillers. The pressure sensitive adhesive composition may comprise 0 to 80 percent by weight of one or more fillers. All individual values and subranges from 0 to 80 weight percent are included herein and disclosed herein. For example, the weight percent of fillers can be from a lower limit of 0.1, 0.2, 0.3, 0.5, 1, 2, 3, 4, 5, 10, 20, 30, or 40 weight percent to an upper limit of 15, 20, 25, 35, 45, 55, 65, 75, or 80 weight percent. Such fillers include, but are not limited to, calcium carbonate, commercially available under the tradename Drikalite™ from the Imeyrys, Victoria, Australia, barium sulfate, aluminum silicate, ceramic micro-spheres, glass micro-spheres, and fly ash.

The pressure sensitive adhesive composition may further include, optionally, one or more freeze-thaw agents. The pressure sensitive adhesive composition may comprise 0.1 to 2 percent by weight of one or more freeze-thaw agents. All individual values and subranges from 0.1 to 2 weight percent are included herein and disclosed herein. F for example, the weight percent of freeze-thaw agents can be from a lower limit of 0.1, 0.2, 0.3, or 0.5 weight percent to an upper limit of 05, 1, 1.5, or 2 weight percent. Freeze-thaw agents, as used herein, refer to additives that typically prevent coagulation of the dispersion when exposed to extreme temperature cycles. Such freeze-thaw agents include, but are not limited to, glycols such as ethylene glycol, diethylene glycol, propylene glycol, dipropylene glycol, butylene glycol, dibutylene glycol. Such glycols are commercially available from the Dow Chemical Company, Midland, Mich.

The pressure sensitive adhesive composition may further include, optionally, one or more neutralizing agents. The pressure sensitive adhesive composition may comprise 0.1 to 2 percent by weight of one or more neutralizing agents. All individual values and subranges from 0.1 to 2 weight percent are included herein and disclosed herein. F for example, the weight percent of neutralizing agents can be from a lower limit of 0.1, 0.2, 0.3, or 0.5 weight percent to an upper limit of 05, 1, 1.5, or 2 weight percent. Neutralizing agents are typically used to control pH to provide stability to the formulated pressure sensitive adhesive composition. Such neutralizing agents include, but are not limited to, aqueous ammonia or aqueous amines, or other aqueous inorganic salts.

The pressure sensitive adhesive composition may further include, optionally, one or more plasticizers. The pressure sensitive adhesive composition may comprise less than 40 percent by weight of one or more plasticizers. All individual values and subranges from less than 40 weight percent are included herein and disclosed herein. F for example, the weight percent of plasticizers can be from a lower limit of 0.1, 0.2, 0.3, 0.5, 1, 2, 3, 4, or 5 weight percent to an upper limit of 10, 20, 30, or 40 weight percent. Such plasticizers are commercially available under the tradename Jayflex™ from ExxonMobil Chemical Company, Texas, USA.

The pressure sensitive adhesive composition may further include, optionally, one or more tackifiers. The pressure sensitive adhesive composition may comprise less than 50 percent by weight of one or more tackifiers. All individual values and subranges from less than 50 weight percent are included herein and disclosed herein. For example, the weight percent of tackifiers can be from a lower limit of 0.1, 0.2, 0.3, 0.5, 1, 2, 3, 4, or 5 weight percent to an upper limit of 10, 20, 30, 40, or 50 weight percent. Some examples of tackifiers include, but are not limited to non-hydrogenated aliphatic C₅ resins, hydrogenated aliphatic C₅ resins, aromatic modified C₅ resins, terpene resins, hydrogenated C₉ resins, and combinations thereof.

The pressure sensitive adhesive composition may further include, optionally, one or more adhesion promoters. The pressure sensitive adhesive composition may comprise less than 5 percent by weight of one or more adhesion promoters. All individual values and subranges from less than 5 weight percent are included herein and disclosed herein. For example, the weight percent of adhesion promoters can be from a lower limit of 0.1, 0.2, 0.3, 0.5, 1, 2, 3, or 4 weight percent to an upper limit of 0.1, 0.2, 0.3, 0.5, 1, 2, 3, 4, 5 weight percent.

The pressure sensitive adhesive composition may further include, optionally, one or more film clarifying additives. The pressure sensitive adhesive composition may comprise less than 5 percent by weight of one or more film clarifying additives. All individual values and subranges from less than 5 weight percent are included herein and disclosed herein. For example, the weight percent of film clarifying additives can be from a lower limit of 0.1, 0.2, 0.3, 0.5, 1, 2, 3, or 4 weight percent to an upper limit of 0.1, 0.2, 0.3, 0.5, 1, 2, 3, 4, 5 weight percent. Exemplary film clarifying additives include, but are not limited to, those commercially available from Eastman Chemical under the tradename Optifilm™ Enhancer 400.

### EXAMPLES

The present invention will now be explained in further detail by showing Inventive Examples, and Comparative Examples, but the scope of the present invention is not, of course, limited to these Examples.

### Comparative Example A

In a 5 liter 4 neck round bottom flask fitted with a stirrer, temperature reading device, condenser and nitrogen inlet, 686 grams of deionized water was heated to 90° C. A solution of 20 grams of deionized (DI) water with 2.5 grams ammonium bicarbonate was added to the reactor followed by a solution of 9.7 grams of sodium persulfate dissolved in 20 grams of DI Water. Both were rinsed to the reactor with 7 grams of water. 103.6 grams of a 45% polymer preform of 100 nm was added with 17 grams of rinse water to the kettle. A monomer pre-emulsion was prepared by agitating together 400 grams of DI water, 23.4 grams of Polystep A-16-22 from Stepan along with 1900 grams butyl acrylate (BA), 60 grams methyl methacrylate (MMA) and 40 grams acrylic acid (AA). The monomer emulsion was fed over 90 minutes along with a cofeed of 3.3 grams of sodium persulfate in 100 grams DI Water. The reactor was maintained at a temperature of ˜87° C. during the feeds. When the feeds were completed, the lines were rinsed to the reactor with 43 grams of water. 26.6 grams of a 0.15% solution of ferrous sulfate heptahydrate was added to the reactor. Residual monomer was reacted using cofeeds of 2.9 grams of 70% t-butylhydroperoxide diluted with 30 grams of water and 2.1 grams of isoascorbic acid dissolved in 35 grams of water fed over one hour with the temperature dropping to 50° C. After 15 minutes at <45° C. the batch was neutralized to pH ˜7-8 with ammonia. The total solids were about 56.5%, the particle size via BI-90˜320 nm and the samples had <100 ppm grit after filtration through a 100 mesh bag.

### Example 1

Same process as in Comparative Example A, except that 100 grams of the butyl acrylate was left out of the pre-emulsion and instead 100 grams of a MMA was added to the emulsion when only 7% remained to be fed.

### Example 2

Same process as in Comparative Example A, except that the 100 grams of MMA was delayed until the last of the pre-emulsion was fed.

Example 3 and 4 were prepared the same way as Example 1, however the monomer added to the last portion of the emulsion feed was butyl methacrylate (BMA) or ethyl acrylate (EA) respectively.

### Comparative Example B

Same process as in Comparative Example A except that when the emulsion feed was completed, the ferrous sulfate was added along with an additional 25% of tBHP and IAA in order to complete the reaction of the first monomer composition. Then the 100 grams of MMA were added followed by another 25% of the tBHP and IAA. The reaction of the MMA generated an exotherm. When the exotherm was complete the reaction was chased as the others.

### Comparative Example C

Same process as in Example 1, however the 100 grams of MMA was added to the last 20% of the emulsion.

The formulations of the Examples are shown in Table 1.

TABLE 1

| | Pre-Emulsion (g) | | | Monomer 2 | | TS | | BI-90 PS | 100 Mesh | Method of |
|---|---|---|---|---|---|---|---|---|---|---|
| | BA | MMA | AA | (g) | | % | pH | (nm) | grit ppm | Mon 2 addition |
| Comp A | 1900 | 60 | 40 | 0 | | 56.7 | 8.3 | 322 | tr | |
| Comp B | 1800 | 60 | 40 | 100 | MMA | 56.2 | 7.1 | 318 | 94 | Chase then |
| | | | | | | | | | | add 5% |
| Comp C | 1800 | 60 | 40 | 100 | MMA | 56.6 | 7.7 | 318 | tr | Added to last |
| | | | | | | | | | | 20% of ME |
| Ex 1 | 1800 | 60 | 40 | 100 | MMA | 56.3 | 8.4 | 312 | 11 | Added to last |
| | | | | | | | | | | 7% of ME |
| Ex 2 | 1800 | 60 | 40 | 100 | MMA | 57.3 | 7.5 | 329 | tr | Added just as ME |
| | | | | | | | | | | feed is complete |
| Ex 3 | 1800 | 60 | 40 | 100 | BMA | 56.9 | 7.6 | 319 | 90 | Added to last |
| | | | | | | | | | | 7% of ME |
| Ex 4 | 1800 | 60 | 40 | 100 | EA | 56.8 | 7.6 | 318 | tr | Added to last |
| | | | | | | | | | | 7% of ME |

As can be seen in Table 2 below, the Comparative Example A sample with no added second monomer mixture had low values for peel and shear. Examples 1-4 all demonstrated an increase in peel and shear. When the MMA was added at the end of the emulsion feed in Example 2, improvements in the properties were still seen when some of the emulsion remains unreacted. If the bulk of the monomer was fully reacted before the addition of the MMA as in Comparative Example B, the shear was very high and the peel was lower than Comparative Example A. When the MMA was added earlier into the emulsion feed as in Comparative Example C, the HDPE peel was not improved.

TABLE 2
Formulation Properties

| | Monomer | Time of | 180° Peel, (SS) | | 180° Peel, (HDPE) | | SS Shear | |
|---|---|---|---|---|---|---|---|---|
| | added | ME | (N/in) | | (N/in) | | (hr) | |
| | 5% | intercept | 20 Min. Dwell | | 24 Hour Dwell | | 1″ × 1″ × 1 kg | |
| Comp A | none | none | 6.7 | C | 7.0 | A/C | 0.1 | C |
| Comp B | MMA | after 100% | 5.9 | A | 3.9 | A | >24 | C |
| Comp C | MMA | last 20% | 13.6 | A/C | 4.9 | A | 2.2 | C |
| Ex 1 | MMA | last 7% | 9.5 | A/C | 10.3 | A/C | 0.3 | C |
| Ex 2 | MMA | at 100% | 11.9 | A/C | 11.7 | A/C | 6.3 | C |
| Ex 3 | BMA | last 7% | 12.1 | A/C | 9.6 | A/C | 1.4 | C |
| Ex 4 | EA | last 7% | 10.6 | A/C | 12.4 | A/C | 2.2 | C |

The examples in Table 2 above were formulated with 30 grams of tackifier (Snowtack 780G) to 70 grams of latex. 0.4 grams of Solusol OT was also added to insure wet out during coating. The samples were direct coated to PET and closed to RP-12 release liner. They were equilibrated at 23° C. and 50% relative humidity before testing. One inch strips were cut and affixed to either stainless steel (SS) or high density polyethylene (HDPE) panels. The samples were allowed to equilibrate 20 min (Dwell) on the SS before the peel was determined or 24 hours on the HDPE. Shear was measured with a 1″×1″ geometry and a 1 kilogram weight. The time in hours at which the weight falls is the shear value. Failure modes are reported as Adhesive (cleanly removes from substrate) or cohesive (where the adhesive goes to both surfaces).

1. A method comprising:
a) dispersing a first monomer mixture, a surfactant, and an initiator in an aqueous medium, the first monomer mixture comprising at least one least monomer and having a total glass transition temperature (Tg) in the range of from −10° C. to −50° C.;
b) when the first monomer mixture is at least 85% dispersed, adding a second monomer mixture to the aqueous medium, the second monomer mixture comprising at least one monomer and having a Tg greater than 20° C. of the Tg of the first monomer mixture; and
c) forming a polymer with the first and second monomer mixtures.

2. A method in accordance with claim 1 wherein the second monomer mixture is added after 90% of the first monomer mixture is dispersed in the aqueous medium.

3. A method in accordance with claim 1 wherein the first monomer mixture comprises a monomer selected from the group consisting of butyl acrylate, ethylhexyl acrylate, ethyl acrylate, methyl acrylate, octyl methacrylate, isooctyl methacrylate, decyl methacrylate, isodecyl methacrylate, lauryl methacrylate, pentadecyl methacrylate, stearyl methacrylate, octyl acrylate, isooctyl acrylate, decyl acrylate, isodecyl acrylate, lauryl acrylate, C₁₂ to C₁₈ alkyl methacrylates, cyclohexyl acrylate, cyclohexyl methacrylate, and combinations thereof.

4. A method in accordance with claim 1 wherein the second monomer mixture is selected from the group consisting of methyl methacrylate, isobutyl methacrylate, ethyl acrylate, and combinations thereof.

5. A pressure sensitive adhesive comprising the polymer formed in claim 1.

6. The pressure sensitive adhesive of claim 5, further comprising a tackifier.
